(19) United States
(12) Patent Application Publication
(10) Pub. No.: US 2006/0165418 A1
(43) Pub. Date: Jul. 27, 2006

(54) Optical signal switching network using method of sub-harmonic embedded clock transmission

(75) Inventors: Keun-joo Park, Yongin-si (KR); Hyun-chin Kim, Seoul (KR); Young-kwang Seo, Seoul (KR); Yeong-bae Yeo, Daegu (KR); Chun-ju Youn, Yongin-si (KR); June-koo Rhee, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/294,544

(22) Filed: Dec. 6, 2005

(30) Foreign Application Priority Data
Jan. 24, 2005 (KR) 2005-6201

(51) Int. Cl. H04B 10/00

(52) U.S. Cl. 398/155

(57) ABSTRACT

An optical signal switching network having a transmitter and a receiver, wherein the transmitter includes a data generator for generating a data signal and a clock signal having the same frequency as the data signal; a clock attenuator for attenuating a frequency of clock signal generated in the data generator at a predetermined ratio; a signal synthesizer for synthesizing the data signal and the attenuated clock signal; a laser generator for generating a laser beam used to transmit the synthesized data signal and clock signal; and a modulator for coupling the synthesized data signal and clock signal to the laser beam and modulating the coupled signal, thereby providing the modulated optical signal to be transmitted to the receiver over an optical fiber

### CROSS REFERENCE TO RELATED APPLICATION

This application claims priority from Korean Patent Application No. 2005-6201, filed on Jan. 24, 2005, the entire content of which is incorporated herein by reference.

### BACKGROUND OF THE INVENTION

1. Field of the Invention

The present invention relates to an optical signal switching network and, more specifically, to an optical signal switching network capable of preventing power of a clock signal from being reduced when transmitting mass data by including a clock signal, having a frequency which is reduced to an inverse number of a double number, in a data signal and transmitting the data signal.

2. Description of the Related Art

In optical communications, data is transmitted over an optical fiber by carrying the data on a laser beam. Recently, as there has been developed a wavelength division multiplexing (WDM) transmission technique to transmit a plurality of data having different wavelengths through one optical fiber, the transmission quantity is increased and, therefore, it becomes possible to meet the transmission traffic accompanied with an explosive demand increase.

In such WDM based optical packet switching technique, it is possible to expand the capacity to a terabit per second or more and it is easy to construct an optical packet routing network whose capacity is more than tens of terabits per second. The optical packet routing scheme has two types, that is, an optical packet switching scheme where the switching is made in a unit of a variable short-length packet and an optical burst switching scheme where the switching is made in a unit of a variable long-length burst.

A procedure where the optical signal is transferred through the optical fiber in the optical packet switching scheme and the optical burst switching scheme will be described below. A transmitter generates an optical signal by carrying a data signal on a laser light and transmits it along an optical fiber. A plurality of nodes are formed on the optical fiber so as to be different optical paths. The optical signal moved along the nodes arrives at a receiver, and the receiver converts the optical signal into electrical signal and determines values of the data signal which has been converted into the electrical signal.

At this time, in order to correctly determine the value of the data signal, it is needed to detect the value of the data signal at a middle position of a square wave indicating the data signal and to decide when and where to extract and determine the data signal. To accomplish this, it is possible to determine a correct value of the data signal by extracting the clock signal having a sinusoidal form from the data signal having a square wave form and determining a position to extract the value of the data signal based on the clock signal.

Since the optical signal is continuously provided in the conventional point-to-point communication, it was possible to consistently extract the value of data signal when the clock signal was initially generated. However, in case of applying the WDM optical packet scheme, many-to-many communication is performed where optical signals generated in many transmitters are transmitted to many receivers, and the optical signals are not consistently transferred to the receiver but transferred to the receiver only when there exists the optical packet data to be provided to the receiver. Accordingly, since the receiver does not receive the optical signals consistently, when the optical signals are suddenly received, a considerable delay time occurs until the clock signal is extracted from the data signal, resulting in a problem that it is not possible to determine the data signal.

In order to solve such a problem, a method was used in which the determination of the data signal is delayed until the clock signal is generated from the data signal by synthesizing an idle signal which has no meaning into an initial area of the data signal and transmitting it. However, such a method has a drawback that it takes too long to determine the data signal since the idle signal period is too long.

Accordingly, an embedded clock scheme has been proposed, where a sender synthesizes the clock signal into the data signal and transmits it. The transmission and reception procedure employing the embedded clock scheme will be schematically described with reference to FIG. 1. When the data signal and clock signal that have the same capacity are synthesized in a sender and provided to a laser generator 10 that generates a laser light, an optical signal having the data signal and clock signal is formed. The optical signal is modulated in a modulator 15. In the embedded clock scheme, the optical signal is modulated with the clock signal having the same frequency as the data signal so that as shown in FIG. 2, the data signal has a predetermined frequency bandwidth of 2B and the clock signal having the same frequency as the data signal is formed before and after the data signal. Accordingly, while the clock signal has one frequency, the data signal has frequencies distributed in the form of spectrum in a desired region.

The modulated optical signal is moved along the optical fiber and provided to the receiver, and the optical-electrical converter 20 converts the optical signal to an electrical signal. The converted electrical signal is amplified at an amplifier 25 and then provided to a data filter 30 and a clock filter 35, so that the data filter 30 extracts the data signal and the clock filter 35 extracts the clock signal. The extracted clock signal is recovered to the original signal in a clock recovery unit 40. The recovered clock signal and data signal are input into the data detector 45 and the data detector 45 determines the value of the data signal depending on the clock signal.

Meanwhile, in general, a color signal of a short wavelength in an optical signal has fast transmission speed and a color signal of a long wavelength has slow transmission speed. Accordingly, while a front region of the sinusoidal wave having a short wavelength in the progress of the clock signal has fast transmission speed, a rear region of the sinusoidal wave having a long wavelength has slow transmission speed, resulting in a chromatic dispersion, that is, a spread of the clock signal. The speed of the spread of the clock signal is accelerated as the capacity of the data signal is increased and the frequency becomes higher.

FIG. 3 is a view showing a chromatic dispersion effect through an experimental result. Referring to FIG. 3, it is noted that power of clock signal is not almost changed in case that the frequency of clock signal is 1 GHz although the length of an optical fiber becomes longer. However, it is noted that power of the clock signal reduces by 50% when the length of the optical fiber reaches 4 km in case that the frequency of clock signal is 4 GHz. The power of the clock signal sharply reduces when the frequency of the clock signal is 6 GHz so that the power of the clock signal reduces by more than 60% when the length of the optical fiber reaches not more than 20 km. That is, it is noted that as the frequency of the data signal becomes higher, the power of the clock signal sharply reduces in proportion to the length of the optical.

Meanwhile, laser light of an electromagnetic wave is polarized and has different transmission speeds in an optical fiber depending on a polarization direction of the electromagnetic wave. It is because a core of the optical fiber is pressurized not in a circular form but in a slightly elliptic form due to the stress occurred when the optical fiber is manufactured. An optical component polarized in a pressurized direction has a transmission speed lower than that of the optical component polarized in a direction not pressurized. Accordingly, as a transmission speed of the optical signal varies depending on a polarized direction of an optical component, the optical signal is distributed which is referred to a polarization mode dispersion. Such a polarization mode dispersion becomes large like the chromatic dispersion as the frequency of the data signal becomes higher and the length of the optical fiber becomes longer.

FIG. 4 is a view showing an experimental result of a polarization mode dispersion. As shown in FIG. 4, it is noted that power of the clock signal gradually becomes lower as the value of Polarization Mode Dispersion (PMD) becomes higher even though the clock signals have the same capacity. Further, it is noted that the power of the clock signal becomes lower as the length of the optical fiber becomes longer since the value of the PMD becomes higher as the length of the optical fiber becomes longer. For example, in case that the frequency of the clock signal is 10 GHz, the capacity of the clock signal is not almost changed when the value of the PMD is 10 ps, the power of the clock signal reduced to 70% when the value of the PMD is 20 ps, and the power of the clock signal reduced to 40% when the value of the PMD is 30 ps. In the case of 30 ps, the power of the clock signal becomes too low to be detected.

Meanwhile, such a phenomenon can occur in a node located on the optical path as well as when the receiver detects the data signal. The node has an optical switch mounted to set the optical path, and the optical switch has a bit synchronizer to synchronize a plurality of optical signals input thereto. The bit synchronizer performs a synchronization of the plurality of optical signals that have phase differences therebetween, according to the clock signal. Accordingly, as described above, when the clock signal is attenuated, it is not possible to perform a task to synchronize the plurality of optical signals in the node.

As such, the frequency of the clock signal sharply becomes higher as the capacity of data abruptly increases recently. And, as described above, effects of chromatic dispersion and polarization mode dispersion sharply increase as the frequency of the data signal becomes higher and the length of the optical fiber becomes longer. Accordingly, the clock signal is resultantly attenuated. Therefore, it is needed to find a method where the clock signal is not attenuated in the course of transmission even when the data signal has a high frequency and the transmission distance is long.

### SUMMARY OF THE INVENTION

The present invention provides an optical signal switching network capable of preventing a value of data signal from not being discriminated due to the used-up of clock signal by preventing power of a clock signal included in a mass optical signal from being reduced to a predetermined value.

According to an aspect of the present invention, there is provided an optical signal switching network comprising a transmitter including: a data generator for generating a data signal and a clock signal having the same frequency as the data signal; a clock attenuator for attenuating a frequency of clock signal generated in the data generator at a predetermined ratio; a signal synthesizer for synthesizing the data signal and the attenuated clock signal and generating an optical signal; a laser generator for generating a laser beam used to transmit the data signal; and a modulator for coupling the optical signal synthesized in the signal synthesizer to the laser beam and modulating the coupled signal, thereby providing the modulated signal to an optical fiber.

The clock attenuator may have at least one ½ attenuator used to attenuate the frequency of the clock signal by an inverse number of a multiple of 2.

The number of ½ attenuator may increase as the frequency of the data signal increases, so as to increase an attenuation ratio of the frequency of the clock signal by a multiple of 2.

The number of the ½ attenuator may increase as the moving distance of the optical signal becomes longer, thereby increasing the attenuation ratio of the frequency of the clock signal by a multiple of 2.

The optical signal switching network may further comprise a receiver including an optical-electrical converter for receiving an optical signal generated in the transmitter and converting the optical signal into an electrical signal; a power splitter for splitting power of the electrical signal converted in the optical-electrical converter; a data filter for extracting the data signal out of one of the split electrical signals; a clock filter for extracting the clock signal out of another of the split electrical signals; and a clock signal multiplier for multiplying the frequency of the clock signal.

The optical signal switching network may further comprise the bit synchronizer including an optical-electrical converter for receiving the optical signal generated in the transmitter and converting the optical signal into an electrical signal; a clock filter for extracting the clock signal from the electrical signal; a clock signal multiplier for multiplying the frequency of the clock signal; a phase difference determining unit for determining phase differences of a plurality of clock signals input from a plurality of the optical channels; and a phase delay unit for delaying the phase of each clock signal selectively and synchronizing phases of clock signals.

The clock signal multiplier may include at least one doubler used to increase the frequency of the clock signal twice.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of an optical signal switching network in the art;

FIG. 2 is a graphical view showing a state of an optical signal modulated in a modulator shown in FIG. 1;

FIG. 3 is a graphical view showing a simulated experimental result for a chromatic dispersion in an optical signal switching network;

FIG. 4 is a graphical view showing a simulated experimental result for a polarized mode dispersion in an optical signal switching network;

FIG. 5 is a block diagram showing an optical switching network in accordance with a first exemplary embodiment of the present invention;

FIG. 6 is a graphical view showing a state of an optical signal modulated in a modulator shown in FIG. 5; and

FIG. 7 is a block diagram showing an optical signal switching network in accordance with a second exemplary embodiment of the present invention.

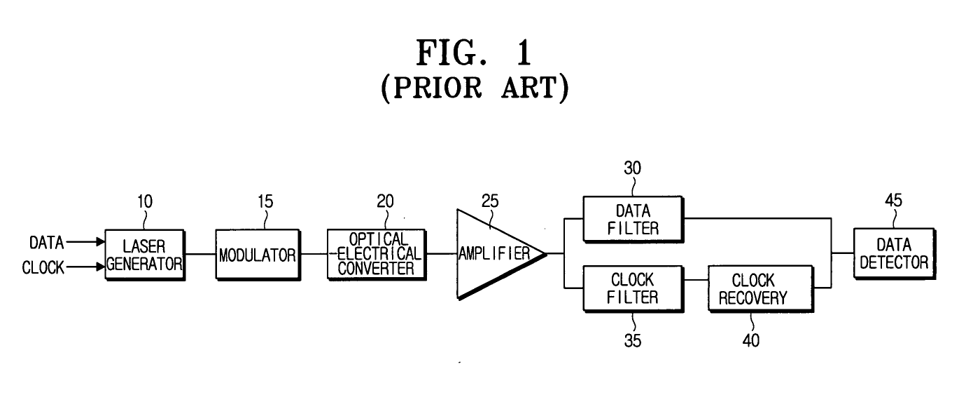

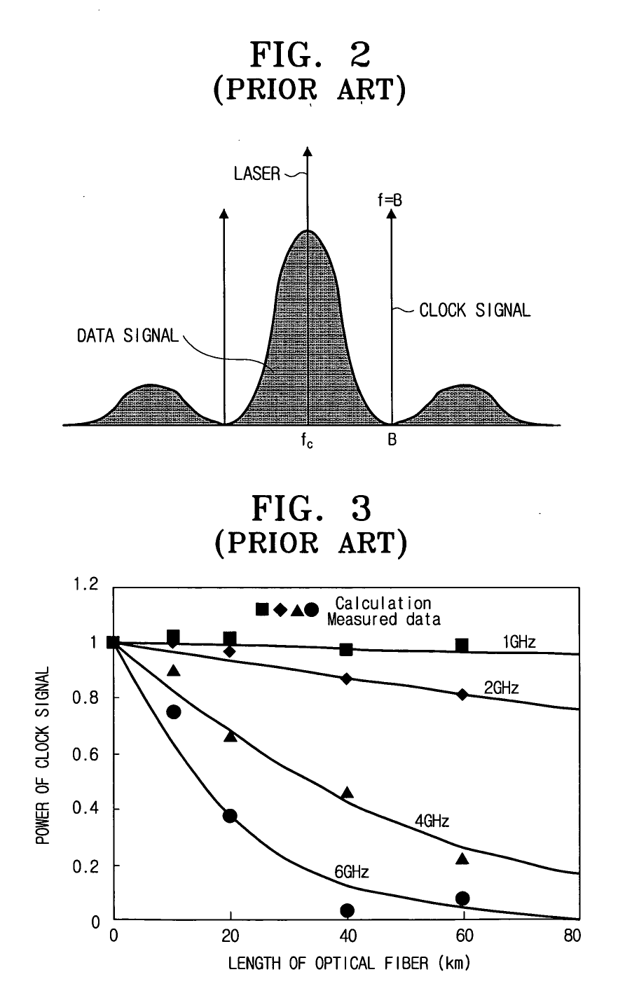

### DETAILED DESCRIPTION OF EXEMPLARY EMBODIMENTS OF THE INVENTION

Hereinafter, a method for matching bit rates of data input to the optical burst switching network and of data output therefrom in accordance with exemplary embodiments of the present invention will be described with reference to the accompanying drawings.

An optical switching network transmits an optical signal applying an optical switching scheme or an optical burst switching scheme, and employs an embedded clock scheme where a clock signal is coupled with a data signal when transmitting the optical signal.

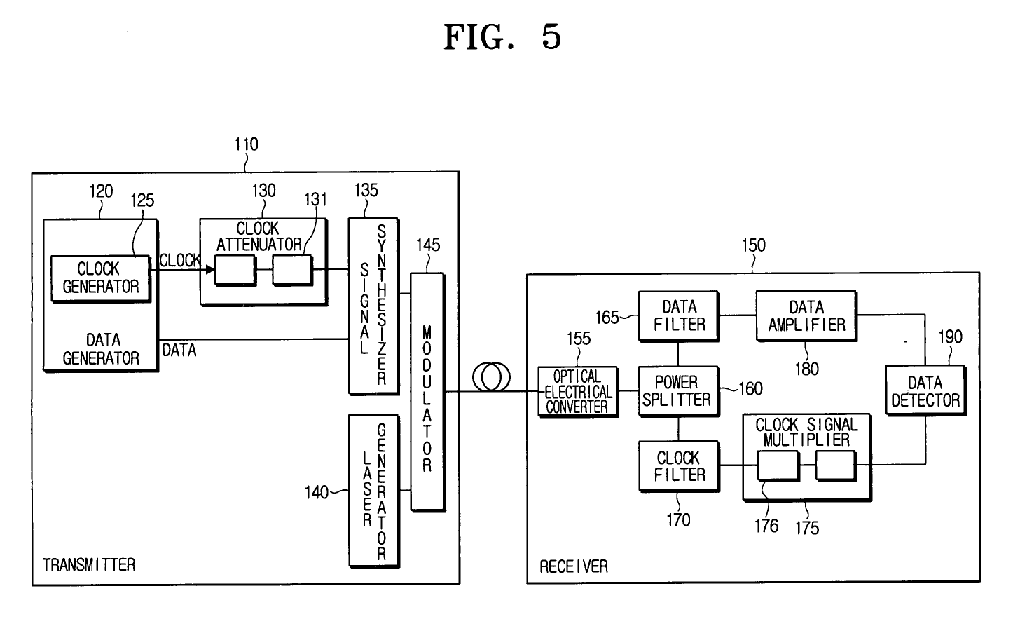

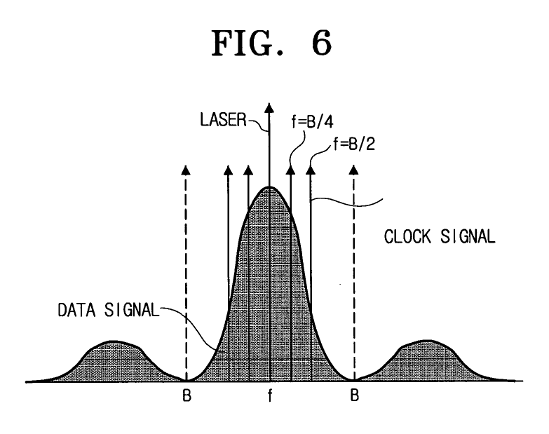

FIG. 5 is a block diagram showing an optical switching network in accordance with a first exemplary embodiment of the present invention. The optical signal switching network is a switching network of a wavelength division multiplexing (WDM) including at least one transmitter 110 for generating an optical signal, and a receiver 150 for receiving an optical signal transmitted through an optical fiber.

The transmitter 110 includes a data generator 120, a clock attenuator 130, a signal synthesizer 135, a laser generator 140, and a modulator 145.

The data generator 120 generates a data signal and a clock signal, that is, a data signal having a mass-frequency ranging a few to tens of GHz and a clock signal having the same frequency as the data signal. The data generator 120 has a clock generator 125 for generating a clock signal, and the clock generator 125 generates a clock signal synchronized with the data signal.

The clock attenuator 130 includes at least one ½ attenuator 131 which attenuates the frequency of the clock signal to ½, that is, attenuates it in a sub-harmonic manner. Since the ½ attenuator 131 attenuates the clock signal to ½, it is possible to attenuate a clock signal to ¼ when two clock attenuators 131 are serially arranged, as shown in FIG. 5. Accordingly, it is needed to arrange three ½ attenuators 131 serially in order to attenuate the frequency of a clock signal to ⅛, and it is needed to arrange four ½ attenuators 131 serially in order to attenuate the frequency of a clock signal to 1/16. That is, one or more ½ attenuators 131 can be arranged depending on a ratio to attenuate the clock signal.

The optical signal switching network determines an attenuation frequency level of the clock signal depending on the frequency of the data signal and a moving distance of the data signal, that is, increases the attenuation frequency level as the frequency of the data signal becomes higher and the moving distance of the data signal becomes longer. For example, referring to the graphical view of the chromatic dispersion experimental result shown in FIG. 3, in case that the frequency of the data signal and clock signal is 4 GHz and the length of the optical fiber, that is, the moving distance is 60 km, power of the clock signal is less than 30% when the clock signal reaches the receiver 150. However, when attenuating only frequency of the clock signal to 2 GHz using the ½ attenuator 131, 80% or more power of the clock signal exists even when the length of the optical fiber reaches 60 km. Accordingly, in this case, there is an effect in which the power of the clock signal increases by more than 50% even when one ½ attenuator 131 is setup in the transmitter 110.

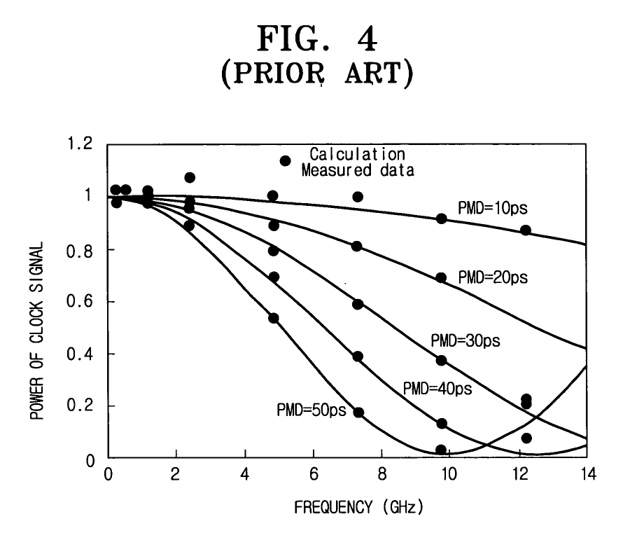

In the same manner, referring to a graphical view of the polarization mode dispersion experimental result shown in FIG. 4, while the power of the clock signal does not reach 20% when a polarization mode dispersion value is 40 ps, and the frequencies of the data signal and clock signal are 10 GHz, it reaches 70% when the frequency of the clock signal is attenuated to 5 GHz using the ½ attenuator 131. Accordingly, when the frequency of the clock signal is attenuated by two by utilizing a single ½ attenuator 131, the power of the clock signal increases by about 50%.

The signal synthesizer 135 synthesizes the clock signal whose frequency was attenuated in the clock attenuator 130 and the data signal from the data generator 120. At this time, as the clock generator 125 generates the clock signal synchronized with the data signal, it synthesizes the data signal and the clock signal attenuated by synchronizing with the data signal.

The laser generator 140 generates a laser beam to transmit the synthesized data signal and clock signal, which can be manufactured of a laser diode or the like. The laser beam used to transmit signals has a wavelength of 1.3 μm or 1.55 μm, and a frequency of 193.1 THz.

The modulator 145 modulates the laser beam generated in the laser generator 140 using the data signal including the attenuated clock signal, and forms a waveform shown in FIG. 6. The modulated data signal forms a sinusoidal wave distributed in a predetermined frequency band, that is, f±B, and a laser data signal is formed in the central region of the data signal. Further, the modulated clock signal is formed in the frequency band of the data signal, and its position is determined depending on the attenuated ratio of the clock attenuator 130. In a case that the frequency of the clock signal is attenuated to a half of the frequency, the clock signal is positioned in the center between one end of the frequency of data signal and the frequency of laser signal. Further, in a case that the frequency of the clock signal is attenuated to ¼ of the frequency, the clock signal is positioned in the center between the location where the frequency of clock signal attenuated to ½ is positioned and the frequency of laser signal. That is, as the attenuation level of the frequency of the clock signal becomes higher, the clock signal is formed in an area closer to the frequency of laser signal.

The optical signal generated in such a transmitter 110 is transmitted through an optical fiber and provided to a receiver 150.

The receiver 150 includes an optical-electrical converter 155, a power splitter 160, a data filter 165, a clock filter 170, a data amplifier 180, a clock signal multiplier 175, and a data detector 190.

The optical-electrical converter 155 converts the optical signal transmitted along the optical fiber into an electrical signal, and the power splitter 160 divides the electrical signal by two and distributes the divided signals into the data filter 165 and the clock filter 170. The data filter 165 extracts the data signal from the electrical signal and provides it to the data amplifier 180, and the data amplifier 180 amplifies the data signal and provides it to the data detector 190.

The clock filter 170 extracts the clock signal from the electrical signal, and provides the extracted clock signal to the clock signal multiplier 175. At this time, the extracted clock signal has a frequency which is attenuated to ½ to 1/16 of the frequency of the data signal in the clock attenuator 130.

The clock signal multiplier 175 consists of at least one doubler 176 used to amplify the frequency of the clock signal two times. Since the doubler 176 amplifies the frequency of the clock signal two times, it is possible to amplify the frequency of the clock signal four times by utilizing two doublers 176. Accordingly, when the clock attenuator 130 of the transmitter 110 attenuates the frequency of the clock signal to a half of it, the receiver 150 has one doubler 176 to amplify the frequency of the clock signal two times, resulting in the clock signal with the same frequency as the data signal. If the clock attenuator 130 attenuated the frequency of the clock signal to ¼ by setting up two ½ attenuators 131, the clock signal multiplier 175 amplifies the frequency of the clock signal four times by utilizing two doublers 176. Accordingly, it is preferable that the ½ attenuator 131 of the clock attenuator 130 utilizes the same number of ½ attenuators as the number of doublers 176 utilized by the clock signal multiplier 175.

The data signal amplified in the data amplifier 180 and the clock signal amplified in the clock signal multiplier 175 are synchronized in the data detector 190, so that the value of the data signal is determined depending on the phase of the clock signal.

A procedure where the optical signal is processed in the transmitter 110 and the receiver 150 of the optical signal switching network of the construction described above will be explained as follows.

The data generator 120 of the transmitter 110 generates the data signal and clock signal. The clock signal is provided to the clock attenuator 130 where its frequency is attenuated to a proper level. At this time, the frequency of the clock signal is attenuated by an inverse number of a multiple of 2, that is, ½, ¼, ⅛ and 1/16, and the number of the ½ attenuators 131 forming the clock attenuator 130 is incremented by 1 as the attenuation ratio is multiplied.

Meanwhile, referring to FIGS. 3 and 4, effects of the chromatic dispersion and polarization mode dispersion reduce as the attenuation ratio of the frequency of the clock signal increases. However, since the clock signal closely approaches to the middle of the frequency of the data signal as the attenuation ratio becomes higher, there is some fear for a distortion of the data signal. Further, when the numbers of the ½ attenuators 131 of the clock attenuator 130 and the doublers 176 within the clock multiplier 175 increase, the transmitter 110 and the receiver 150 become complicated in construction and larger in size. Accordingly, the attenuation ratio of the clock signal should be determined at a proper level where the distortion of the data signal occurs as little as possible and effects of the chromatic dispersion and polarization mode dispersion become lower.

The attenuated data signal and data signal are synthesized in the signal synthesizer 135 and provided to the modulator 145, and coupled with the laser beam to be modulated in the modulator 145. The modulated optical signal is transmitted along the optical fiber to the receiver 150.

The optical signal received at the receiver 150 is converted into the electrical signal in the optical-electrical converter 155. The electrical signal is divided by the power splitter 160 and the divided electrical signals are provided to the data filter 165 and the clock filter 170, respectively. The data filter 165 and clock filter 170 extract the data signal and clock signal, respectively. The extracted data signal is provided to the data amplifier 180 to be amplified and the clock signal is provided to the clock signal multiplier 175.

The clock signal multiplier 175 multiplies the frequency of the attenuated clock signal and recovers it to a former state where the clock signal has not been attenuated in the transmitter 110. The recovered clock signal and data signal are provided to the data detector 190, and the data detector 190 synchronizes the clock signal and data signal, and then determines the value of the data signal depending on the clock signal.

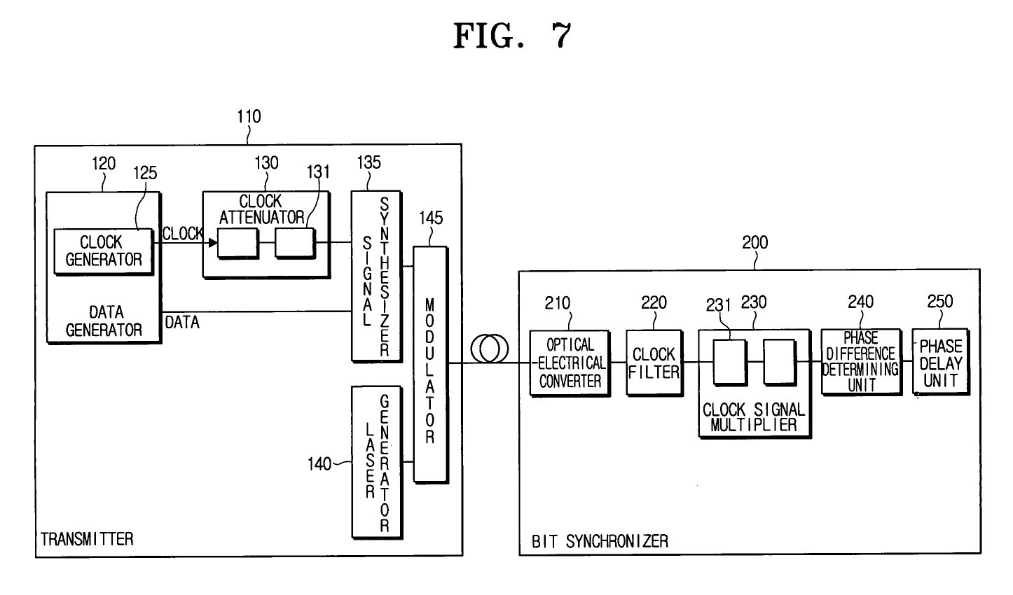

Meanwhile, FIG. 7 is a block diagram showing an optical signal switching network in accordance with a second exemplary embodiment of the present invention.

The optical signal switching network includes a transmitter 110 for generating an optical signal and a node which setups an optical path of the optical signal provided from the transmitter 110 and provides the bit synchronizer 200 with the optical signal. A description of a construction of the transmitter 110 is omitted since it is the same as the exemplary embodiment describe above.

The node generally has an optical switch for setting up an optical path of the optical signals, and a bit synchronizer 200 for matching phases of the optical signal input from a plurality of optical channel.

The bit synchronizer 200 includes an optical-electrical converter 210, a clock filter 220, a clock signal multiplier 230, a phase difference determining unit 240 and a phase delay unit 250.

The optical-electrical converter 210 converts the optical signal transmitted along the optical fiber into the electrical signal, and the clock filter 220 extracts a clock signal from the electrical signal.

The clock signal multiplier 230 consists of at least one doubler 231 which amplifies the frequency of the clock signal twice in the same manner of the receiver 150 described above. The number of doublers 231 is the same as the number of the ½ attenuators 131 of the clock attenuator 130. Accordingly, the clock signal multiplier 230 amplifies the frequency of the received clock signal with the frequency of the data signal.

The phase difference determining unit 240 compares a plurality of clock signals input through different optical channels and determines the level of the phase difference between both clock signals.

When there is a phase difference between both clock signals in the phase difference determining unit 240, the phase delay unit 250 delays one clock signal until its phase becomes the same as that of another clock signal, and removes the phase difference of both clock signals.

A procedure where an optical signal is processed in the transmitter 110 and the bit synchronizer 200 of the optical signal switching network using such a construction is explained as follows.

The transmitter 110 generates the clock signal of the data signal as is in the exemplary embodiment described above, attenuates only the clock signal by an inverse number of multiples of 2. Further, the transmitter 110 transmits the attenuated clock signal together with the data signal via the laser beam through the optical fiber.

The optical signal which is transmitted along the optical fiber has an optical path setup by the node, and the bit synchronizer 200 of the node synchronizes the data signal within the optical signal provided from a plurality of optical channels and transmits the synchronized data signal to its node. To accomplish this, the optical-electrical converter 210 converts a respective optical signal into electrical signal and extracts a respective clock signal. Further, the optical-electrical converter 210 amplifies the frequency of the respective clock signal by a multiple of 2 in the reverse manner of the transmitter 110 and recovers the frequency to a former state where it has been attenuated in the transmitter 110.

Next, the phase difference between data signals is determined by comparing a plurality of clock signals included in different optical channels with each other, and the data signal of one side is delayed for a while in order to remove the determined phase difference, and provided to its node.

As such, the optical signal switching network attenuates the clock signal by an inverse number of a multiple of 2, that is, a sub-harmonic using the clock attenuator 130 in the transmitter. Then, the optical signal switching network includes the attenuated clock signal in the data signal and transmits it to the receiver 150 or the bit synchronizer 200 of the node. Further, the receiver 150 or the bit synchronizer 200 recover the clock signal to its original state by amplifying the attenuated clock signal by a multiple of 2 using the clock signal multiplier 175 or 230. By attenuating the frequency of the clock signal and including it in the data signal, it is possible to reduce the frequency of the original clock signal to ½, ¼, ⅛ and 1/16 of the frequency of the original clock signal while maintaining the frequency of the data signal due to the increase of the capacity of the data. Accordingly, since the frequency of the clock signal reduces, as the frequency becomes higher and the transmission length becomes longer, the effects of the chromatic dispersion and polarization mode dispersion increase, so that it is possible to prevent the clock signal from being decreased abruptly. Accordingly, it is possible to determine the value of the data signal precisely.

The foregoing embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. An optical signal switching network comprising a transmitter comprising:
a data generator which generates a data signal and a clock signal having a same frequency as the data signal;
a clock attenuator which attenuates a frequency of the clock signal generated by the data generator at a predetermined ratio;
a signal synthesizer which synthesizes the data signal and the attenuated clock signal;
a laser generator which generates a laser beam used to transmit the synthesized data signal and clock signal; and
a modulator which couples the synthesized data signal and clock signal to the laser beam and modulates a coupled signal to generate an optical signal to be transmitted over an optical fiber.

2. The network as claimed in claim 1, wherein the clock attenuator includes at least one ½ attenuator which attenuates the frequency of the clock signal by an inverse number of a multiple of 2.

3. The network as claimed in claim 2, wherein the clock attenuator includes a plurality of ½ attenuators, and a number of the ½ attenuators increases as the frequency of the data signal increases, so as to increase an attenuation ratio of the frequency of the clock signal by a multiple of 2.

4. The network as claimed in claim 2, wherein the clock attenuator includes a plurality of ½ attenuators, and a number of the ½ attenuators increases as a travel distance of the optical signal becomes longer, thereby increasing the attenuation ratio of the frequency of the clock signal by a multiple of 2.

5. The network as claimed in claim 1, further comprising a receiver comprising:
an optical-electrical converter which receives the optical signal generated by the modulator of the transmitter and converts the optical signal into an electrical signal;
a power splitter which divides a power of the electrical signal converted by the optical-electrical converter and outputs first and second divided electrical signals;
a data filter which extracts the data signal from the first divided electrical signal;
a clock filter which extracts the clock signal from the second divided electrical signal; and
a clock signal multiplier which multiplies the frequency of the clock signal.

6. The network as claimed in claim 1, further comprising the bit synchronizer including:
an optical-electrical converter which receives the optical signal generated by modulator of the transmitter and converts the optical signal into an electrical signal;
a clock filter which extracts the clock signal from the electrical signal;
a clock signal multiplier which multiplies the frequency of the clock signal;
a phase difference determining unit which determines phase differences of a plurality of clock signals input from a plurality of optical channels; and
a phase delay unit which selectively delays the phase of each clock signal and synchronizes phases of clock signals.

7. The network as claimed in claim 5, wherein the clock signal multiplier includes at least one doubler which increases the frequency of the clock signal by a factor of 2.

8. The network as claimed in claim 6, wherein the clock signal multiplier includes at least one doubler which increases the frequency of the clock signal by a factor of 2.

9. The network as claimed in claim 7, wherein the clock signal multiplier includes a plurality of doublers, and a number of the doublers increases in proportion to an attenuation ratio of the frequency of the clock signal attenuated in the clock attenuator.

10. The network as claimed in claim 8, wherein the clock signal multiplier includes a plurality of doublers, and a number of the doublers increases in proportion to an attenuation ratio of the frequency of the clock signal attenuated in the clock attenuator.

11. The network as claimed in claim 9, wherein the clock attenuator includes a plurality of ½ attenuators which attenuate the frequency of the clock signal by an inverse number of a multiple of 2, and the number of the doublers of the clock signal multiplier is the same as a number of the ½ attenuators.

12. The network as claimed in claim 10, wherein the clock attenuator includes a plurality of ½ attenuators which attenuate the frequency of the clock signal by an inverse number of a multiple of 2, and the number of the doublers of the clock signal multiplier is the same as a number of the ½ attenuators.

13. An optical signal switching network comprising a transmitter and a receiver, wherein the transmitter comprises:
a data generator which generates a data signal and a clock signal having a same frequency as the data signal;
a clock attenuator which attenuates a frequency of the clock signal generated by the data generator at a predetermined ratio;
a signal synthesizer which synthesizes the data signal and the attenuated clock signal;
a laser generator which generates a laser beam used to transmit the synthesized data signal and clock signal; and
a modulator which couples the synthesized data signal and clock signal to the laser beam and modulates a coupled signal to generate an optical signal to be transmitted over an optical fiber, and
wherein the receiver comprises:
an optical-electrical converter which receives the optical signal generated by the modulator of the transmitter and converts the optical signal into an electrical signal;
a power splitter for divides power of the electrical signal converted in the optical-electrical converter and outputs first and second divided electrical signals;
a data filter which extracts the data signal from the first divided electrical signal;
a clock filter which extracts the clock signal from the second divided electrical signal; and
a clock signal multiplier which multiplies the frequency of the clock signal.

14. The network as claimed in claim 13, wherein the clock attenuator includes at least one ½ attenuator which attenuates the frequency of the clock signal by an inverse number of a multiple of 2.

15. The network as claimed in claim 14, wherein the clock attenuator includes a plurality of ½ attenuators, and a number of ½ attenuators increases as the frequency of the data signal increases, so as to increase an attenuation ratio of the frequency of the clock signal by a multiple of 2.

16. The network as claimed in claim 14, wherein the clock attenuator includes a plurality of ½ attenuators, and a number of the ½ attenuator increases as a distance over which the optical signal travels becomes longer, thereby increasing an attenuation ratio of the frequency of the clock signal by a multiple of 2.

17. The network as claimed in claim 13, wherein the clock signal multiplier includes at least one doubler which increases the frequency of the clock signal by a factor of two.

18. The network as claimed in claim 17, wherein the clock signal multiplier includes a plurality of doublers, and a number of the doublers increases in proportion to an attenuation ratio of the frequency of the clock signal attenuated in the clock attenuator.

19. An optical signal switching network comprising a transmitter and a node, wherein the transmitter comprises:
a data generator which generates a data signal and a clock signal having a same frequency as the data signal;
a clock attenuator which attenuates a frequency of the clock signal generated by the data generator at a predetermined ratio;
a signal synthesizer which synthesizes the data signal and the attenuated clock signal;
a laser beam generator for generating a laser beam used to transmit the synthesized data signal and clock signal; and
a modulator which couples the synthesized data signal and clock signal to the laser and modulates a coupled signal to generate an optical signal to be transmitted over an optical fiber, and
wherein the node comprises:
an optical-electrical converter which receives the optical signal generated by the modulator of the transmitter and converts the optical signal into an electrical signal;
a clock filter which extracts the clock signal from the electrical signal;
a clock signal multiplier which multiplies the frequency of the clock signal;
a phase difference determining unit which determines phase differences of a plurality of clock signals input from a plurality of optical channels; and
a bit synchronizer including a phase delay unit which selectively delays each of the clock signals and synchronizes phases of the clock signals.

20. The network as claimed in claim 19, wherein the clock attenuator includes at least one ½ attenuator which attenuates the frequency of the clock signal at an inverse number of a multiple of 2.

21. The network as claimed in claim 20, wherein the clock attenuator includes a plurality of ½ attenuators and a number of the ½ attenuators increases as the frequency of the data signal increases, so as to increase an attenuation ratio of the frequency of the clock signal by a multiple of 2.

22. The network as claimed in claim 20, wherein the clock attenuator includes a plurality of ½ attenuators and a number of the ½ attenuator increases as a distance over which the optical signal travels becomes longer, thereby increasing an attenuation ratio of the frequency of the clock signal by a multiple of 2.

23. The network as claimed in claim 20, wherein the clock signal multiplier includes at least one doubler which increases the frequency of the clock signal twice.

24. The network as claimed in claim 16, wherein the clock signal multiplier includes a plurality of doublers and a number of the doublers increases in proportion to an attenuation ratio of the frequency of the clock signal attenuated in the clock attenuator.
